(19) United States
(12) Patent Application Publication
(10) Pub. No.: US 2021/0073552 A1
(43) Pub. Date: Mar. 11, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Takenori MATSUO, Kanagawa (JP)

(73) Assignee: FUJI XEROX CO., LTD., Tokyo (JP)

(21) Appl. No.: 16/818,322

(22) Filed: Mar. 13, 2020

(30) Foreign Application Priority Data
Sep. 6, 2019 (JP) 2019-163139

(51) Int. Cl. G06K 9/00; H04N 21/845; G06F 3/0488; G06F 3/0484

(52) U.S. Cl. CPC G06K 9/00765; G06K 9/00671; H04N 21/8455; G06K 9/00751; G06F 3/0488; G06F 3/0484; G06K 9/00456

(57) ABSTRACT

An information processing apparatus includes a receiver that receives, from a user, an operation of specifying order of plural frames in an image, and a generator that generates output data associated with the image so that pieces of digitization data in the plural frames are arranged based on the specified order.

### CROSS-REFERENCE TO RELATED APPLICATIONS

This application is based on and claims priority under 35 USC 119 from Japanese Patent Application No. 2019-163139 filed Sep. 6, 2019.

### BACKGROUND

### (i) Technical Field

The present disclosure relates to an information processing apparatus and a non-transitory computer readable medium storing a program.

### (ii) Related Art

In a meeting using a whiteboard, one or more users write texts or the like at any timings wherever they like on the whiteboard. The user often takes a photograph of the whiteboard used in the meeting to record what was discussed in the meeting. However, the texts or the like were written on the whiteboard in an arbitrary layout, and the photograph does not tell the flow of the discussion. Thus, the conclusion is hard to locate in the information on the whiteboard.

There is an apparatus that recognizes, in real time, texts handwritten on a whiteboard or a touch panel display and outputs the texts as text data.

The following technologies are provided as technologies for character recognition on handwritten texts.

Japanese Unexamined Patent Application Publication No. 2016-162372 describes an apparatus that detects a gesture of a user's finger on a projected image of a document such as a medical record and detects a user's operation instruction based on the gesture for the purpose of character recognition for the document and data entry based on the character recognition. This apparatus receives gestures or the like for operations of specifying a field in the image for recognition, associating the field in the image with an item to be entered, and adding an attribute value to the item.

Japanese Unexamined Patent Application Publication No. 9-130521 discloses a text data output whiteboard. An image of the whiteboard is split into cells and texts in the cells are recognized. The recognition process is executed for a plurality of cells different in size, thereby recognizing texts different in size. The recognized texts and images which are not recognized due to misalignment from the cells are applied to a matrix position format, thereby identifying texts belonging to the same row and rearranging character recognition results in the respective rows.

### SUMMARY

Aspects of non-limiting embodiments of the present disclosure relate to the following circumstances. In digitization of an image showing a written field such as a whiteboard where a plurality of text groups are placed in an arbitrary layout, the individual texts may be digitized by simply applying the related-art character recognition technology. In the related-art digitization technology such as a character recognition technology, however, the order of the plurality of written texts is not determined. Therefore, output data is not generable in the form of, for example, a record of meeting, in which a plurality of texts are arranged in the order of text writing.

It is desirable to generate output data in which pieces of information in frames in an image are arranged in the order of the frames even if the order of the frames is not determined based on the contents of the image.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus comprising a receiver that receives, from a user, an operation of specifying order of a plurality of frames in an image, and a generator that generates output data associated with the image so that pieces of digitization data in the plurality of frames are arranged based on the specified order.

### BRIEF DESCRIPTION OF THE DRAWINGS

An exemplary embodiment of the present disclosure will be described in detail based on the following figures, wherein:

FIG. 1 exemplifies the functional configuration of a mobile terminal of an exemplary embodiment;

FIG. 2 exemplifies a processing procedure to be executed by an application;

FIG. 3 exemplifies templates;

FIG. 4 exemplifies an image overlaid with a template;

FIG. 5 illustrates a non-text portion (blank) in the image;

FIG. 6 exemplifies the image split into a plurality of frames along the non-text portion serving as a boundary;

FIG. 7 illustrates the order of text data array included in the frames in a generated electronic document;

FIG. 8 exemplifies a processing procedure to be executed by an application having a function of receiving an operation of specifying the order of frames by touch gestures;

FIG. 9 exemplifies a detailed procedure related to S24 and S26 of FIG. 8;

FIG. 10 exemplifies a digitization-target image;

FIG. 11 exemplifies the image split into a plurality of frames;

FIG. 12 illustrates touch gestures for specifying the order of the frames;

FIG. 13 illustrates a touch gesture for specifying a frame to be excluded from the digitization target;

FIG. 14 illustrates a touch gesture for specifying a frame where texts and other objects are acquired as image data without OCR;

FIG. 15 exemplifies an electronic document including the image data in the image acquisition frame and OCR text data in the other frames;

FIG. 16 illustrates a touch gesture for specifying a data format of the electronic document;

FIG. 17 partially exemplifies a processing procedure to be executed by an application that receives touch gestures for various instructions;

FIG. 18 is a continuation of the procedure of FIG. 17; and

FIG. 19 illustrates touch gestures for specifying the order of a plurality of images.

### DETAILED DESCRIPTION

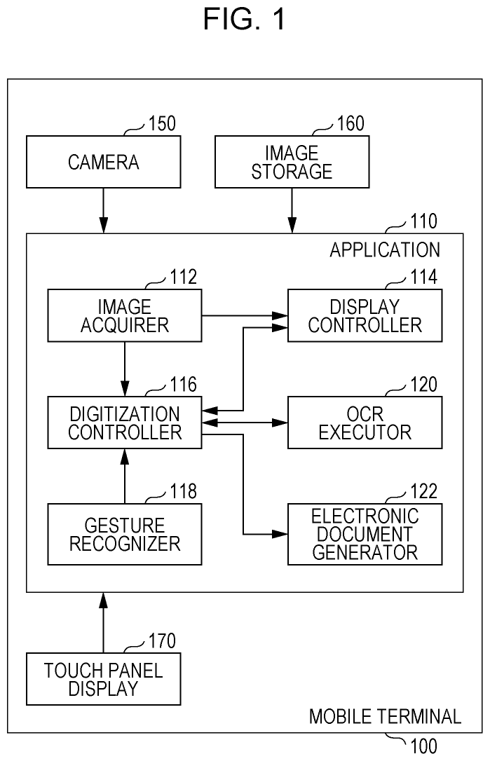

FIG. 1 exemplifies the functional configuration of a mobile terminal 100 according to an exemplary embodiment of the present disclosure. For example, the mobile terminal 100 is a smartphone or a tablet terminal including a computer, a camera 150, and a touch panel display 170.

The mobile terminal 100 includes an image storage 160. The image storage 160 is a storage area for images (i.e., photographs) captured by the camera 150. Examples thereof include the Camera Roll in “iOS” (registered trademark) provided by Apple Inc.

The computer of the mobile terminal 100 has an application (i.e., application software) 110 installed to digitize an image showing a written text field into an electronic document in a predetermined format. Examples of the written text field include a whiteboard or a page in a notepad with handwritten texts. The image digitization to be executed by the application 110 includes a process of converting texts in the image into text data. The “digitization” herein means that a target image is converted from image data into an electronic document in a predetermined data format.

The application 110 includes, as functional modules, an image acquirer 112, a display controller 114, a digitization controller 116, a gesture recognizer 118, an OCR executor 120, and an electronic document generator 122.

The image acquirer 112 acquires a digitization-target image from the camera 150 or the image storage 160. The display controller 114 performs control for displaying a digitization-target image or a screen for receiving an operation for image digitization. The digitization controller 116 controls an overall process for digitizing an image. The gesture recognizer 118 recognizes a user's touch gesture on the touch panel display 170 to grasp details of operation for the application 110. For example, the user makes a touch gesture with his/her finger on a screen of the touch panel display 170.

The OCR executor 120 executes optical character recognition (OCR) for an input image. An OCR function of other software in the mobile terminal 100 or an OCR service provided outside the mobile terminal 100, for example, on the Internet may be used instead of providing the OCR executor 120 in the application 110.

The electronic document generator 122 generates an electronic document in a predetermined data format in association with an input image based on, for example, text data obtained through OCR for the image. Examples of the data format of the electronic document generated by the electronic document generator 122 include PDF and Docuworks (registered trademark), but the data format is not limited thereto.

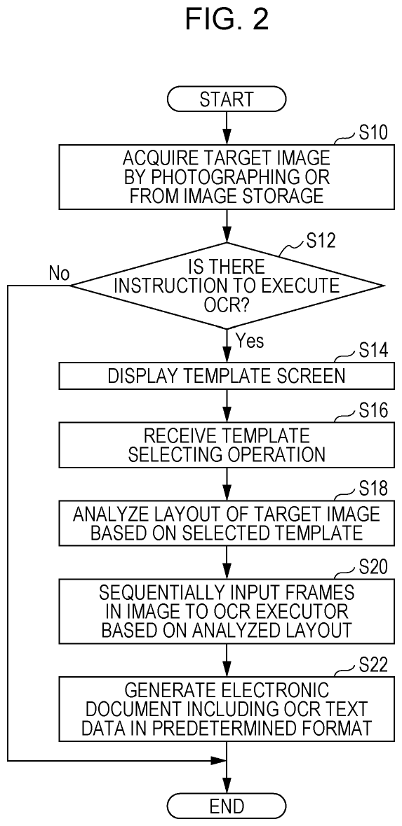

FIG. 2 exemplifies a processing procedure of image digitization to be executed by the application 110.

When a user activates the application 110 on the mobile terminal 100, the display controller 114 of the application 110 displays a menu screen on the touch panel display 170. The menu screen shows several menu items such as “Take photo for digitization” and “Choose image from storage for digitization”.

If the user selects the menu item “Take photo for digitization” on the menu screen, the application 110 activates the camera 150 via an operating system (OS) of the mobile terminal 100. The user takes a photograph of a written text field such as a whiteboard by using the camera 150 while viewing a scene that is being shot by the camera 150 and displayed on the touch panel display 170. The image acquirer 112 acquires the photograph captured by the camera 150 as a digitization-target image (S10).

If the user selects the menu item “Choose image from storage for digitization” on the menu screen, the application 110 causes, via the OS of the mobile terminal 100, the touch panel display 170 to display a list of images in the image storage 160. The user selects a digitization-target image from the image list. The image acquirer 112 acquires the selected image file from the image storage 160 (S10).

The image acquirer 112 may acquire a digitization-target image from an image storage provided outside the mobile terminal 100 (e.g., a cloud image storage for the user).

The display controller 114 causes the touch panel display 170 to display the digitization-target image acquired by the image acquirer 112.

After the digitization-target image is displayed, the digitization controller 116 receives a user's instruction. For example, the user may instruct the digitization controller 116 to execute OCR for the image by selecting a menu item “Execute OCR” from a menu screen provided by the application 110. The application 110 determines whether the input user's instruction is execution of OCR (S12). If the user's instruction is not execution of OCR (i.e., “No” in S12), the application 110 executes a process (not illustrated) in response to the instruction and terminates the procedure of FIG. 2.

If the result of the determination in S12 is “Yes”, the application 110 causes, via the display controller 114, the touch panel display 170 to display a template screen (S14). The template screen shows templates. The template is data indicating the order of OCR for a plurality of frames in the digitization-target image (e.g., an image showing a whiteboard).

For example, it is assumed that several persons have a meeting while taking notes on a whiteboard. The persons write some texts in any blank areas on the whiteboard as appropriate. Since the persons write texts in this manner, an image showing the whiteboard with texts may be split into a plurality of frames. The semantic order of the texts in the plurality of frames (e.g., the order of arrangement of the frames) is not uniquely determined from the image.

The template defines the order of frames. In the example of FIG. 2, the user selects a template appropriate to the digitization-target image from among a plurality of templates each defining the order of frames.

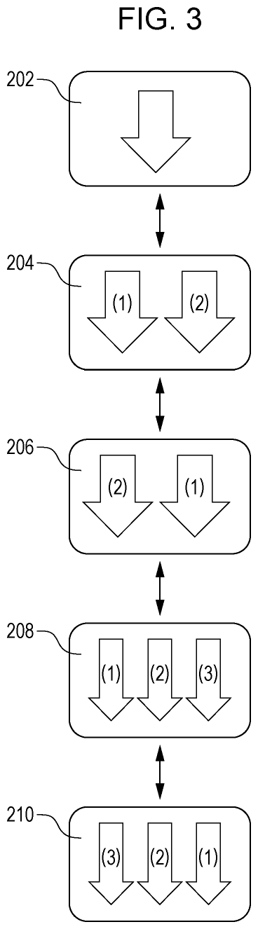

FIG. 3 exemplifies a plurality of templates 202 to 210. The templates 202 to 210 are provided under the assumption that texts are written horizontally in the written text field such as a whiteboard. The template 202 indicates that the digitization-target image is composed of one top-to-bottom frame. The template 204 indicates that the image is composed of two frames arranged in the order of left to right. The template 206 indicates that the image is composed of two frames arranged in the order of right to left. The template 208 indicates that the image is composed of three frames arranged in the order of left to right. The template 210 indicates that the image is composed of three frames arranged in the order of right to left.

The templates 202 to 210 illustrated in FIG. 3 are merely examples. Any type of template may be employed, such as a template adapted to vertical text orientation.

The template screen displayed in S14 may be a list of the templates 202 to 210 exemplified in FIG. 3. The user selects a template to be applied to the digitization-target image from the list.

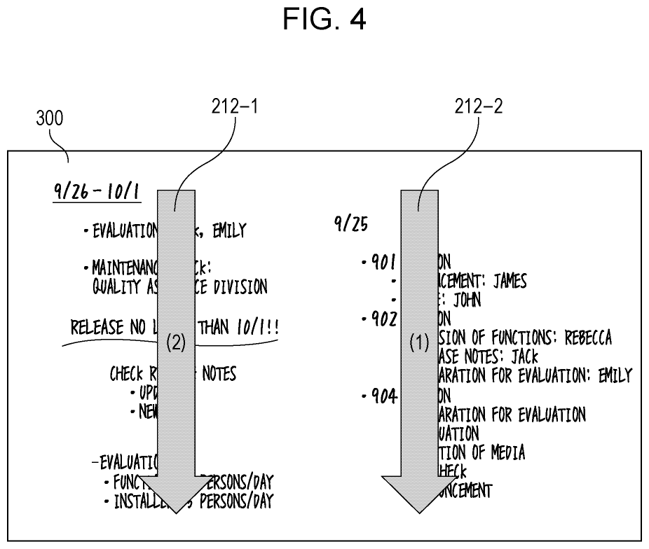

FIG. 4 exemplifies another example. In S14, a template may be laid over a digitization-target image 300 displayed on the touch panel display 170. In this overlay display, the image 300 is seen through the template. In FIG. 4, arrows 212-1 and 212-2 represent marks showing the template 206 exemplified in FIG. 3. The template laid over the image 300 is switched to other templates by a predetermined action such as flicking on the touch panel display 170. The user checks whether the template laid over the image 300 is appropriate to the image 300 based on the marks of the template. If the template is appropriate, the user selects the template by a predetermined action such as double-tapping on the touch panel display 170.

The digitization controller 116 receives the user's template selecting operation (S16) and analyzes the layout of the digitization-target image based on the template (S18). That is, the digitization controller 116 splits the image into a plurality of frames based on the template and determines the order of the plurality of frames based on the template. The digitization controller 116 inputs, to the OCR executor 120, images in the frames in the order determined through the layout analysis based on the template (S20).

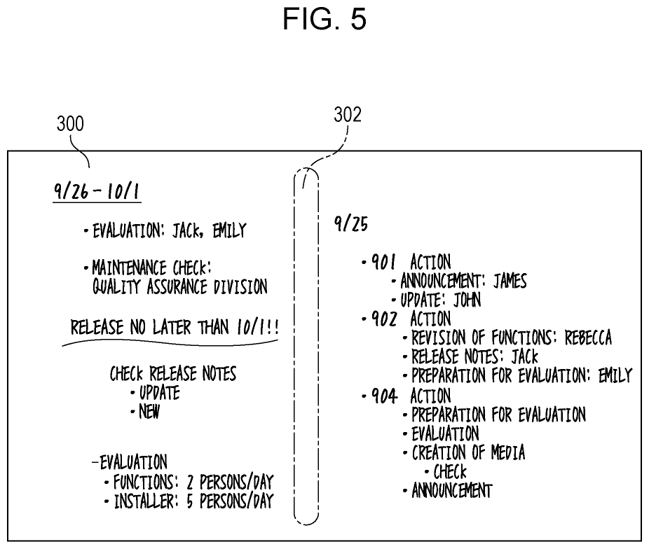

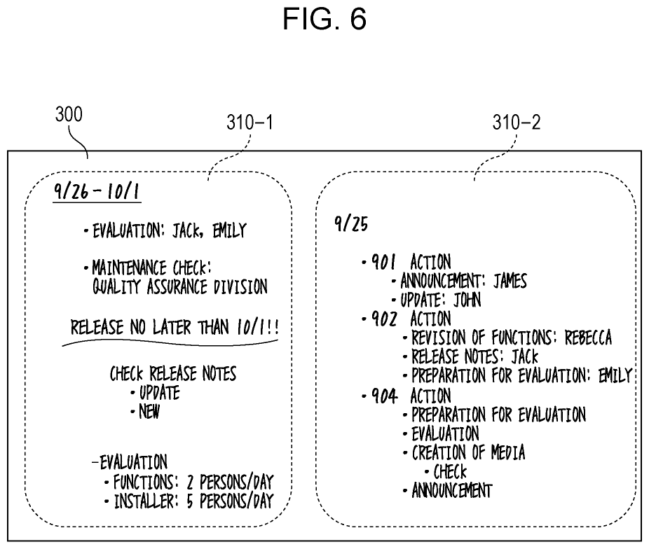

For example, in response to selection of a double-frame template as exemplified in FIG. 4, the digitization controller 116 splits the digitization-target image 300 into two frames. The image 300 is split into the plurality of frames based on a handwritten line in the image 300 or a string of non-text portion in the image 300. The non-text portion is a blank area in the image 300 or a portion including objects other than text (e.g., shapes). FIG. 5 exemplifies a non-text portion 302 near the center of the image 300 in a lateral direction. The non-text portion 302 continuously extends in a vertical direction. In the process of S18, the image 300 is split into two right and left frames 310-1 and 310-2 across the non-text portion 302 as illustrated in FIG. 6. In S20, an image in the frame 310-2 is first input to the OCR executor 120 and an image in the frame 310-1 is then input to the OCR executor 120 based on the order indicated by the template of FIG. 4 (i.e., the template 206 of FIG. 3).

The OCR executor 120 executes publicly-known OCR for the images in the frames input in the order described above. The OCR executor 120 returns OCR text data to the digitization controller 116.

For example, when the template is selected as exemplified in FIG. 4, the texts are written horizontally in the frames. That is, the arrows 212-1 and 212-2 of the template each represent a direction of an array of rows of the written texts. Therefore, a lateral direction perpendicular to the arrow direction is a direction in which the texts are written in each row. In this case, the digitization controller 116 instructs the OCR executor 120 to execute OCR under the assumption that the texts are written horizontally. The OCR executor 120 executes OCR in the order of the image in the frame 310-2 and the image in the frame 310-1, and returns OCR text data in the frame 310-2 and OCR text data in the frame 310-1 to the digitization controller 116.

The digitization controller 116 transfers, to the electronic document generator 122, the pieces of text data sequentially returned from the OCR executor 120. The electronic document generator 122 generates a file including the input text data (i.e., an electronic document) in a predetermined data format (S22). The user may select the data format of the electronic document to be generated.

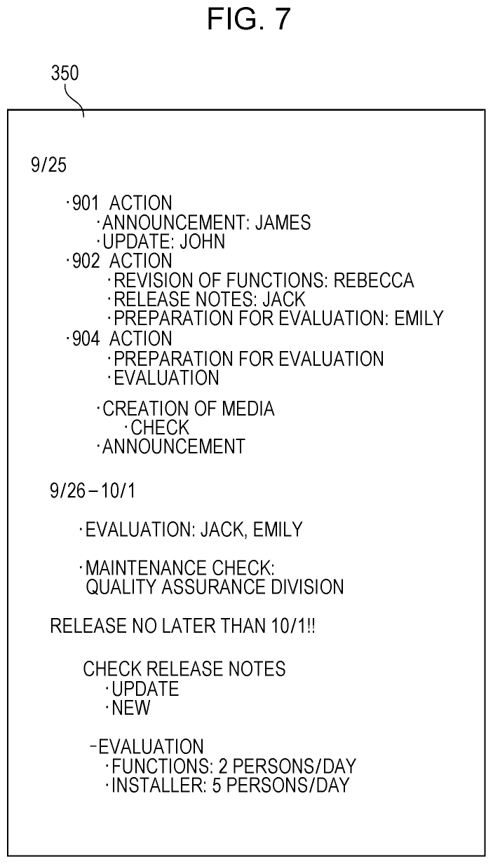

For example, when the template is selected for the image 300 as exemplified in FIG. 4, an electronic document 350 is generated so that the text data in the frame 310-2 and the text data in the frame 310-1 are arranged in the order from the top row as illustrated in FIG. 7.

In the example described above, the user selects a template to specify the order of OCR for the digitization-target image. The application 110 executes OCR for the frames based on the order indicated by the selected template, thereby generating an electronic document in which pieces of OCR text data in the frames are arranged in this order.

In the example described above, the process of displaying the template screen (S14) and receiving the user's template selecting operation (S16) is an example of a “receiver that receives, from a user, an operation of specifying the order of a plurality of frames in an image”. The electronic document generator 122 is an example of a “generator that generates output data associated with the image so that pieces of digitization data in the plurality of frames are arranged based on the specified order”. The pieces of OCR text data in the frames 310-1 and 310-2 obtained by splitting the image 300 are examples of the “pieces of digitization data” in the frames.

In the example described above, priority levels of the templates to be presented to the user on the template screen in S14 may be determined based on the frame structure of the digitization-target image. For example, when the image 300 is acquired as exemplified in FIG. 5 (S10), the application 110 analyzes the image 300 before the template screen is displayed (S14). Thus, the application 110 determines that the image 300 may be split into the two frames 310-1 and 310-2 across the non-text portion 302. Among the plurality of templates 202 to 210 of the application 110 (see FIG. 3), the templates 204 and 206 match the two laterally arranged frames 310-1 and 310-2. Therefore, the templates 204 and 206 are presented to the user with higher priority levels than those of the other templates 202, 208, and 210. In the example in which the list of the templates 202 to 210 is displayed, the templates 204 and 206 are displayed in the order from the top of the list and the remaining templates 202, 208, and 210 are displayed subsequently. In the example in which the templates to be laid over the image 300 are switched by flicking, the template 204 or 206 is first laid over the image 300. The laid template is switched to the other by flicking, and is switched to the remaining template 202, 208, or 210 by another flicking.

### Example of Specifying Order by Touch Gestures

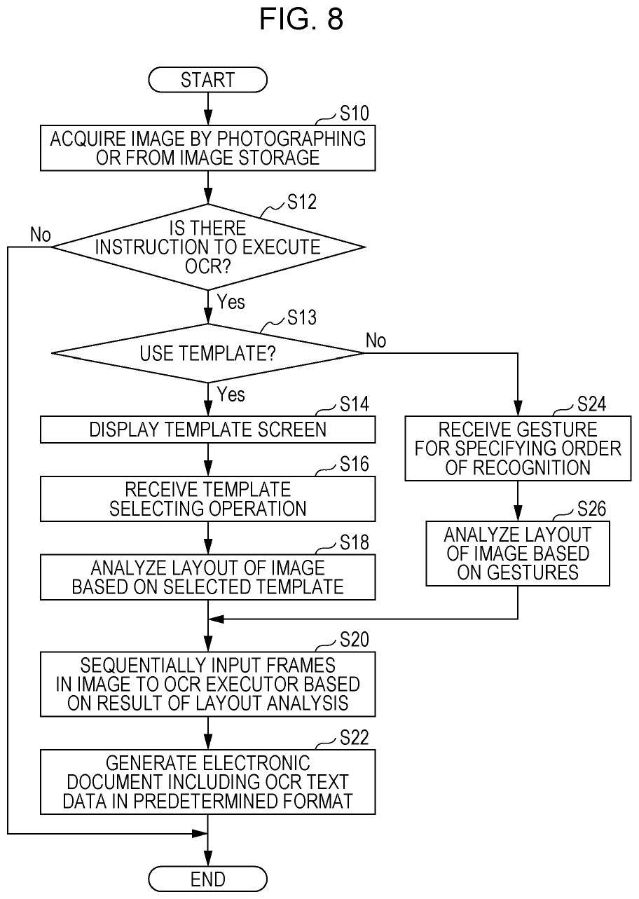

Referring to FIG. 8 to FIG. 12, description is made of an example of an application 110 having a function of specifying the order of frames in a digitization-target image by touch gestures on the touch panel display 170.

FIG. 8 illustrates a processing procedure to be executed by the application 110 of this example. In FIG. 8, steps similar to those of FIG. 2 are represented by the same step numbers and description thereof is omitted.

In the procedure of FIG. 8, the digitization controller 116 of the application 110 receives, between S12 and S14, a user's instruction as to whether to use a template for specifying the order of frames (S13). If the user instructs the digitization controller 116 to use a template, the digitization controller 116 executes S14 to S22 similarly to the procedure of FIG. 2.

If the result of the determination in S13 is “No”, the digitization controller 116 enters a mode in which the digitization controller 116 receives a gesture for specifying the order of recognition of frames in the image (S24). In this mode, the user makes a touch gesture by drawing a line with his/her finger on the surface of the touch panel display 170, thereby specifying the order of recognition of the frames. The gesture recognizer 118 recognizes the user's touch gesture and the digitization controller 116 analyzes the layout of the image based on the recognized touch gesture (S26). Then, the processes of S20 and S22 are executed similarly to the procedure of FIG. 2.

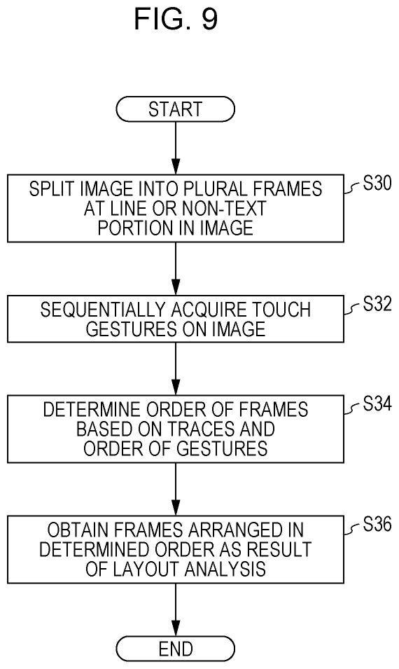

FIG. 9 illustrates a detailed example of the processes of S24 and S26. In this procedure, the digitization controller 116 splits the digitization-target image into a plurality of frames along a line or non-text portion in the image as a boundary (S30). The gesture recognizer 118 recognizes a finger trace of a touch gesture on the screen of the touch panel display 170. If a plurality of touch gestures are made sequentially, the gesture recognizer 118 recognizes finger traces of the respective touch gestures (S32).

The digitization controller 116 determines the order of the frames in the image based on the finger traces of the touch gestures and the order of input of the touch gestures (S34). That is, the direction in which the finger moves by one touch gesture (i.e., a finger trace formed within a period in which the finger touches the screen and then moves off the screen) defines the order of frames located along the finger trace, and the order of input of the touch gestures defines the order of all the frames in the image. Thus, the order of the frames is specified by the series of touch gestures.

The digitization controller 116 obtains the frames determined in S30 and the order of the frames determined in S34 as a result of the layout analysis (S36).

The digitization controller 116 inputs, to the OCR executor 120, images in the frames in the order shown in the result of the layout analysis (S20). Pieces of text data output from the OCR executor 120 are arranged in the order of output and the arrangement of text data is represented in a predetermined data format. Thus, an electronic document is generated (S22).

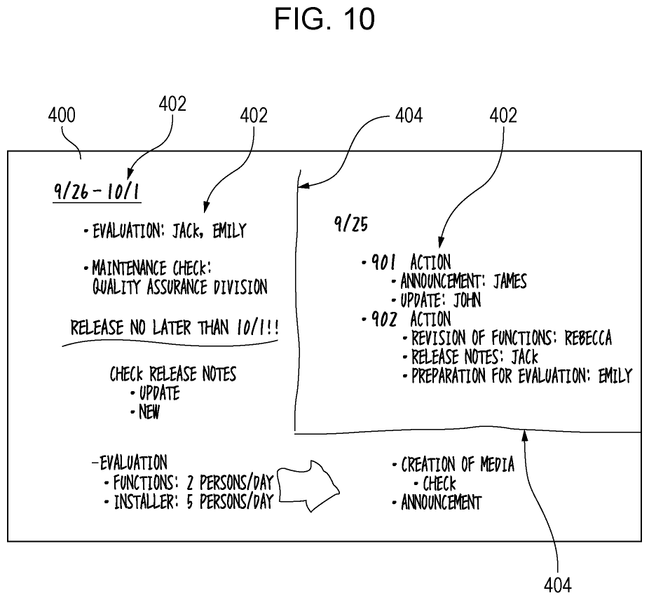

Description is made of a specific example of the process of FIG. 9. In this specific example, the image acquirer 112 acquires a digitization-target image 400 illustrated in FIG. 10. The user inputs an instruction to specify the order of OCR for the image by touch gestures instead of a template.

The image 400 illustrated in FIG. 10 shows a whiteboard and includes images showing texts 402 handwritten on the whiteboard, and images showing separator lines 404 drawn to separate one area from the other on the whiteboard.

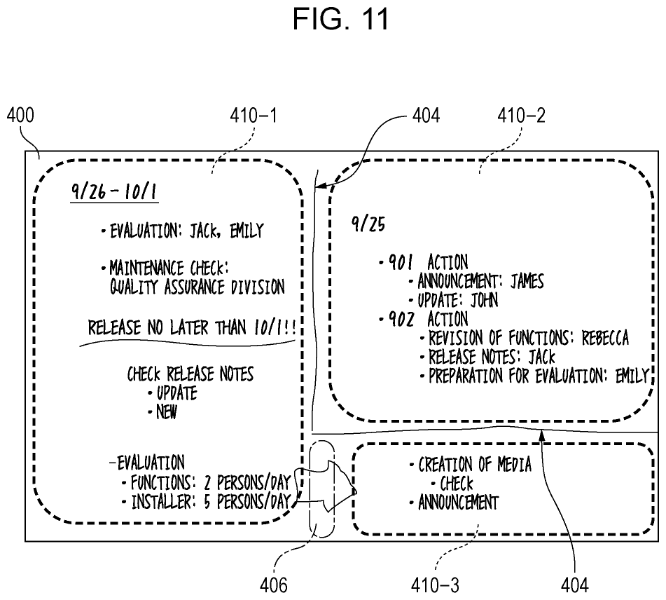

In S30, as illustrated in FIG. 11, the image 400 is split into three frames 410-1, 410-2, and 410-3 by the two separator lines 404 and a non-text portion (i.e., portion with no text) 406 below the vertical separator line 404.

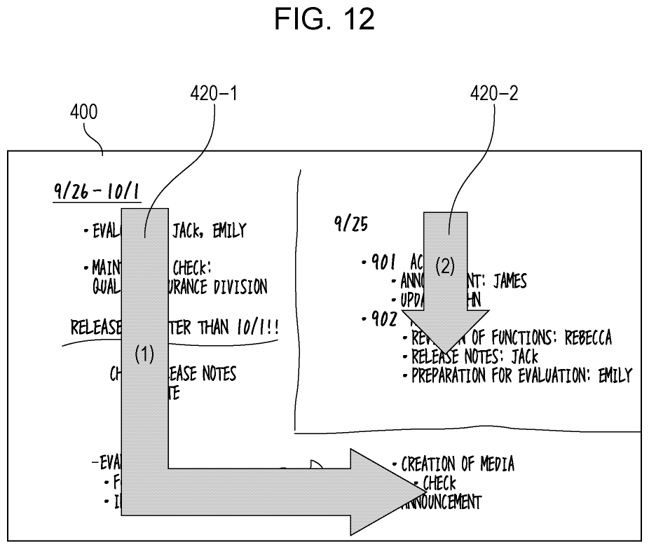

In S32, as illustrated in FIG. 12, the user of the mobile terminal 100 makes a touch gesture 420-1 and then a touch gesture 420-2 on the screen of the touch panel display 170 that displays the image 400. In FIG. 12 and other figures illustrating touch gestures, the user's finger trace formed on the screen is represented by “touch gesture 420-1” or the like. The touch gestures 420-1 and 420-2 each indicate that the user's finger has moved in the arrow direction in the figure. For example, the touch gesture 420-1 indicates that the user's finger touches the top center of a left half of the image 400, moves downward and then rightward by turning at about 90 degrees near the bottom, and moves off the screen.

In S34, the order of the frames is determined from the touch gestures 420-1 and 420-2 such that the frame 410-1 is first, the frame 410-3 is second, and the frame 410-2 is third. Thus, the OCR executor 120 executes OCR in the order of the frame 410-1, the frame 410-3, and the frame 410-2. Then, an electronic document is generated so that pieces of OCR text data in the frame 410-1, the frame 410-3, and the frame 410-2 are arranged in this order.

In the example illustrated in FIG. 10 or the like, the separator line 404 is a continuous line, but the digitization controller 116 may recognize a broken line or other noncontinuous lines as a continuous separator line by a publicly-known technology.

In the example described above with reference to FIG. 8 to FIG. 12, the user may specify the order of execution of OCR for the image 400 by touch gestures.

### Touch Gestures for Instructions Other than Specifying Order

The application 110 may receive touch gestures for instructions other than the instruction to specify the order of OCR.

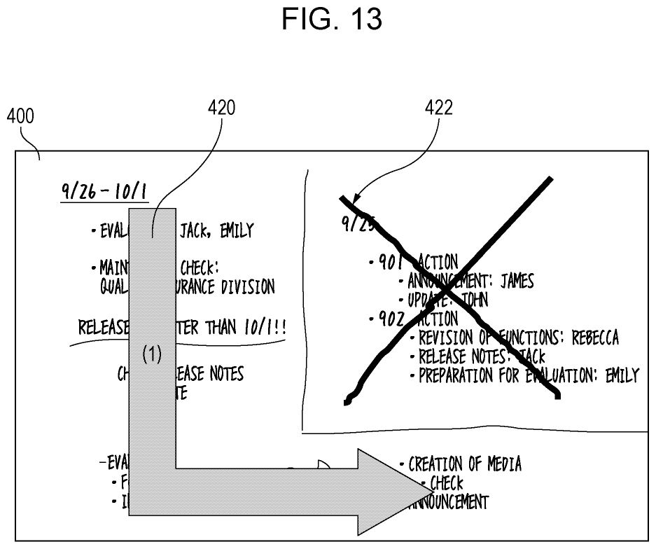

In an example illustrated in FIG. 13, the user makes, on the image 400, not only a touch gesture 420 for specifying the order of OCR but also a touch gesture 422 for specifying a frame to be excluded from the digitization target. The exclusion touch gesture 422 is made by drawing an X-shaped trace with the finger. That is, the exclusion touch gesture 422 is made by drawing a first line in an oblique direction with the finger touching the screen and then drawing a second line intersecting the first line with the finger in a direction substantially orthogonal to that of the first line. The gesture recognizer 118 recognizes the exclusion touch gesture 422. The gesture recognizer 118 reports the instruction for exclusion and positional information of the touch gesture 422 in the image 400 to the digitization controller 116. For example, the reported positional information indicates sets of coordinates of the ends of the two lines that define the X-shaped touch gesture 422 (i.e., a total of four sets of coordinates).

The digitization controller 116 that receives the report recognizes that the frame including the touch gesture 422 is excluded from the digitization target based on the reported positional information and the frames obtained by splitting the image in S30. In the example of FIG. 13, the frame 410-2 illustrated in FIG. 11 is excluded from the digitization target. Information about an image in the frame excluded from the digitization target is not included in the electronic document to be generated.

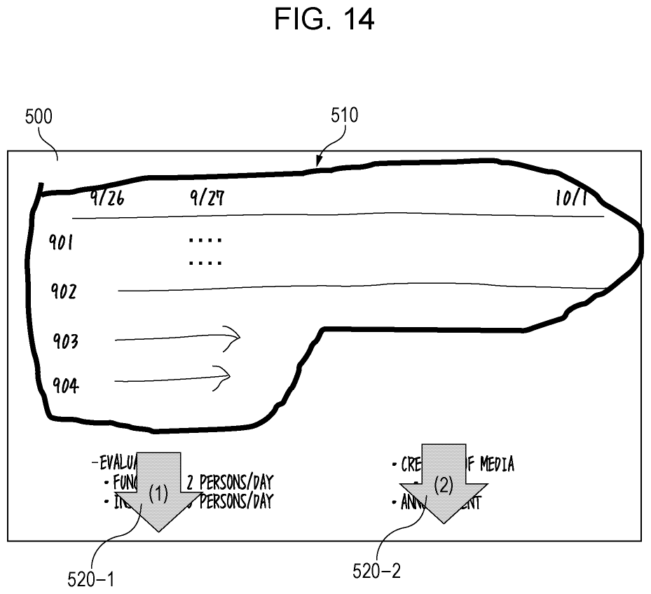

FIG. 14 exemplifies an image acquisition touch gesture 510 for specifying a frame in which texts and other objects are included into an electronic document as image data without OCR. In the example of FIG. 14, a frame enclosed by a finger trace of the touch gesture 510 is the frame in which texts and other objects are acquired as image data. In other words, the finger trace of the image acquisition touch gesture 510 is a closed curve that encloses a frame of interest. The trace need not be a complete closed curve. For example, a trace which is not completely closed due to a gap between start and end points may be recognized as a closed curve by filling the gap if the gap is equal to or smaller than a predetermined length.

In the example of FIG. 14, the frame enclosed by the touch gesture 510 is a table. Information on the table structure may be lost if OCR is simply executed. In this example, the texts and other objects in this frame are included into the electronic document as image data including the information on the table structure. Image elements such as a drawing and a picture other than the table, which are not recognized as texts, may also be included into the electronic document by using the image acquisition touch gesture 510.

In the example of FIG. 14, the user makes, on the image 500, not only the image acquisition gesture 510 but also touch gestures 520-1 and 520-2 for specifying the order of OCR.

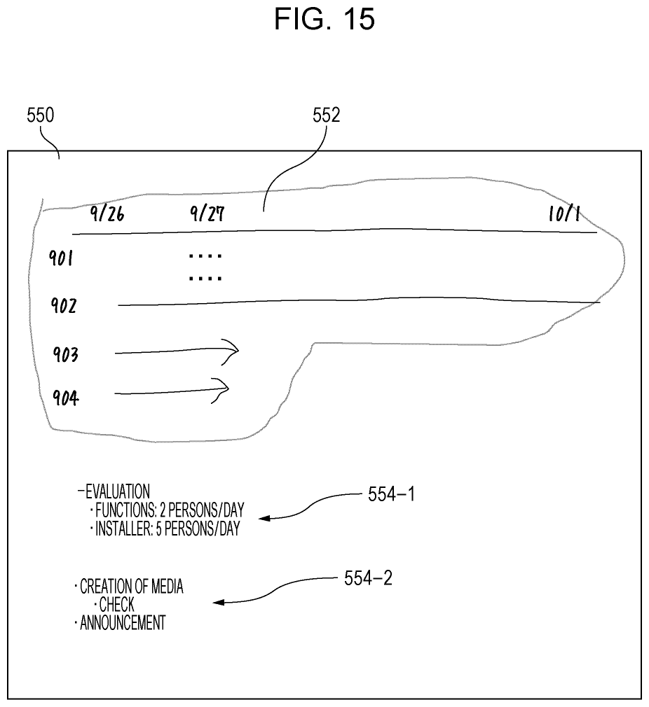

FIG. 15 exemplifies details of an electronic document 550 generated by the application 110 based on the touch gestures 510, 520-1, and 520-2 exemplified in FIG. 14. In the electronic document 550 illustrated in FIG. 15, pieces of OCR text data 554-1 and 554-2 are arranged below image data 552 in the frame specified by the image acquisition touch gesture 510 in the order specified by the OCR-order specifying touch gestures 520-1 and 520-2. The positional relationship between the image data 552 and the pieces of text data 554-1 and 554-2 in the electronic document 550 is based on the positional relationship between the respective frames in the original image 500.

The image data 552 and the pieces of text data 554-1 and 554-2 in the electronic document 550 exemplified in FIG. 15 are examples of the “pieces of digitization data” obtained by digitizing the images in the corresponding frames in the original image 500 (i.e., partial images in the original image). The “digitization” of images to be executed by the application 110 involves converting the partial images in the frames in the original image into pieces of digitization data in formats specified by the user, and generating a file (i.e., an electronic document) in a predetermined data format by arranging the pieces of digitization data in the frames.

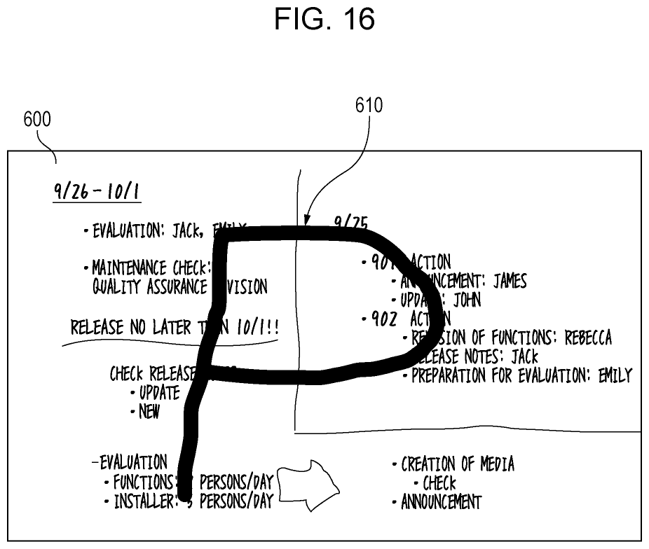

FIG. 16 exemplifies a touch gesture 610 for specifying a data format of the electronic document to be generated by the electronic document generator 122. The touch gesture 610 is made by drawing a P-shaped trace representing “PDF” with the finger on an image 600. Symbols and shapes to be drawn by the finger may be determined for touch gestures for specifying data formats supported by the electronic document generator 122.

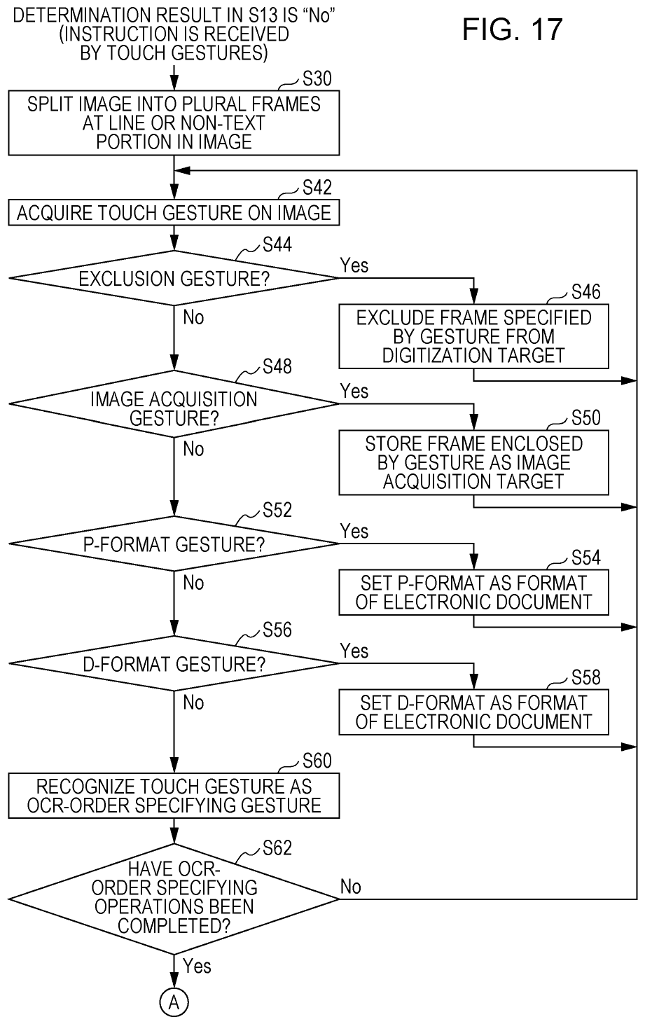

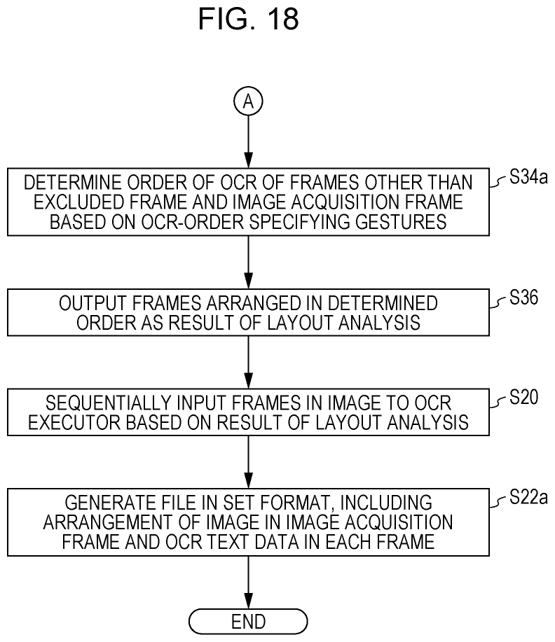

FIG. 17 and FIG. 18 exemplify a processing procedure to be executed by the application 110 that receives OCR-order specifying touch gestures and touch gestures for other instructions. S24, S26, S20, and S22 in the procedure illustrated in FIG. 8 are replaced with the steps in the procedure illustrated in FIG. 17 and FIG. 18. In the procedure of FIG. 8, the processes of S14 to S22 in the case where the result of the determination in S13 is “Yes” may be the same as those described above.

In this example, the electronic document generator 122 may generate electronic documents in two data formats that are “P-format” and “D-format”.

As illustrated in FIG. 17, if the result of the determination in S13 is “No”, the digitization controller 116 splits the digitization-target image into a plurality of frames along a line or non-text portion in the image (S30). This step is similar to S30 illustrated in FIG. 9.

The gesture recognizer 118 recognizes a touch gesture on the screen of the touch panel display 170 (S42). The gesture recognizer 118 determines whether the recognized touch gesture indicates exclusion (S44), image acquisition (S48), the P-format as the format of the electronic document (S52), or the D-format as the format of the electronic document (S56).

If the result of the determination in S44 (whether the gesture indicates exclusion) is “Yes”, the digitization controller 116 stores a frame associated with the position and range of the exclusion touch gesture as a frame to be excluded from the digitization target (S46). If the result of the determination in S48 is “Yes”, the digitization controller 116 stores a frame enclosed by the image acquisition touch gesture as an image acquisition target frame (S50). If the result of the determination in S52 is “Yes”, the digitization controller 116 sets the P-format as the data format of the electronic document to be generated by the electronic document generator 122 (S54). If the result of the determination in S56 is “Yes”, the digitization controller 116 sets the D-format as the data format of the electronic document to be generated by the electronic document generator 122 (S58). If no touch gesture is input to specify the data format, the electronic document generator 122 generates the electronic document in a default data format.

If the results of the determination in S44, S48, S52, and S56 are “No”, the digitization controller 116 recognizes that the touch gesture acquired in S42 is an OCR-order specifying gesture (S60).

The digitization controller 116 determines whether the OCR-order specifying operations for the digitization-target image using touch gestures are completed (S62). In this case, the digitization controller 116 determines whether OCR-order specifying touch gestures are input to determine the order of all the remaining frames other than the frame excluded in S46 and the image acquisition target frame stored in S50 among the frames in the image split in S30. That is, the digitization controller 116 determines whether all the remaining frames are covered by the frames located along the traces of one or more OCR-order specifying touch gestures received after S30.

If the result of the determination in S62 is “No”, the digitization controller 116 returns to S42 and further receives a touch gesture. If the result of the determination in S62 is “Yes”, the digitization controller 116 proceeds to the procedure of FIG. 18.

In the procedure of FIG. 18, the digitization controller 116 determines, based on the received OCR-order specifying touch gestures, the order of the frames in the image other than the frame excluded by the instruction for exclusion and the frame specified as the image acquisition target (S34a). The process of S34a is similar to S34 of FIG. 9. Next, the digitization controller 116 obtains the frames arranged in the order determined in S34a as a result of the layout analysis (S36) and inputs images in the frames to the OCR executor 120 based on the analysis result (S20). The processes of S36 and S20 are similar to those in the procedures of FIG. 8 and FIG. 9.

The digitization controller 116 inputs, to the electronic document generator 122, image data in the image acquisition target frame and pieces of OCR text data sequentially output from the OCR executor 120. The electronic document generator 122 generates an electronic document including the image data and the text data (S22a). The generated electronic document does not include data on a partial image in the frame excluded in S46. If a touch gesture is made to specify a data format, the electronic document generator 122 generates, in S22a, an electronic document in the format specified by the touch gesture.

In the digitization-target image, texts written in a specific color or texts in a frame enclosed by a line in a specific color may be distinguished from the other texts. In this example, in response to detection of the texts written in the specific color or the texts in the frame enclosed by the line in the specific color in the digitization-target image, the application 110 provides a predetermined emphasizing attribute to OCR text data of the detected texts. Examples of the emphasizing attribute include an attribute with which text data is displayed in a specific color (e.g., red), and an attribute with which text data is displayed in bold type. The generated electronic document includes the text data provided with the emphasizing attribute.

Although the digitization of one image is described above, a plurality of images may be selected from the image storage 160 or the like, digitized sequentially, and output as one electronic document. In this case, the user may make touch gestures to specify the order of the plurality of images. This order is referred to as “image order” for distinction from the order of frames in one image.

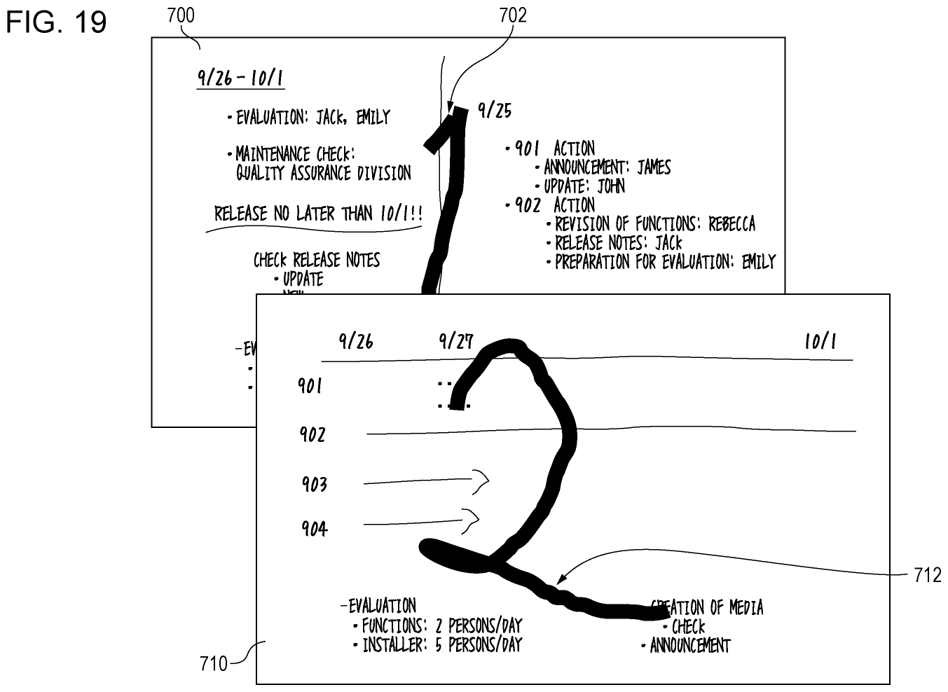

In an example illustrated in FIG. 19, the user makes touch gestures on a plurality of images 700 and 710 to draw numerals 702 and 712 for specifying the image order. In response to the gesture recognizer 118 detecting the touch gestures for drawing the numerals on the images, the digitization controller 116 recognizes that the numerals define the image order of the plurality of images. The digitization controller 116 reports the recognized image numbers to the electronic document generator 122. The electronic document generator 122 generates an electronic document by arranging, in the order of the image numbers, pieces of digitization data (i.e., image data in an image acquisition frame or OCR text data) in frames in the respective images.

The mobile terminal 100 of the exemplary embodiment described above is implemented by causing the computer of the mobile terminal 100 to execute a program that describes the functional elements of the mobile terminal 100. For example, the computer has, as hardware, a circuit structure in which a processor, a memory (main memory) such as a random-access memory (RAM), a controller that controls an auxiliary memory such as a flash memory, a solid-state drive (SSD), or a hard disk drive (HDD), various input/output (I/O) interfaces, and a network interface that controls connection to a network such as a local area network are connected via a bus. The program that describes details of processes of the functions is stored in the auxiliary memory via the network or the like and is installed in the computer. The functional modules exemplified above are implemented in such a manner that the program stored in a fixed memory is read in the memory and is executed by the processor.

The term “processor” refers to hardware in a broad sense. Examples of the processor include general processors (e.g., CPU: Central Processing Unit), and dedicated processors (e.g., GPU: Graphics Processing Unit, ASIC: Application Specific Integrated Circuit, FPGA: Field Programmable Gate Array, and programmable logic device).

In the exemplary embodiment and the reference examples, the term “processor” is broad enough to encompass one processor or plural processors in collaboration which are located physically apart from each other but may work cooperatively. The order of operations of the processor (i.e., processing operations of the elements of FIG. 1 that are implemented by the operation of the processor) is not limited to one described in the exemplary embodiment, and may be changed.

Although the exemplary embodiment of the present disclosure is applied to the mobile terminal 100, the exemplary embodiment may be applied to an information processing apparatus other than the mobile terminal 100 (e.g., a personal computer).

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus, comprising:
a receiver that receives, from a user, an operation of specifying order of a plurality of frames in an image; and
a generator that generates output data associated with the image so that pieces of digitization data in the plurality of frames are arranged based on the specified order.

2. The information processing apparatus according to claim 1, wherein the receiver receives, from the user, an operation of selecting a template to be applied to the image from among a plurality of templates that define the order of the plurality of frames.

3. The information processing apparatus according to claim 2, wherein the receiver lays the template over the image displayed on a screen so that the image is visible, and receives, from the user, an instruction as to whether to apply the laid template to the image.

4. The information processing apparatus according to claim 2, further comprising a splitter that splits the image into the plurality of frames along a line or a non-text portion in the image,
wherein the receiver sets a higher priority level to, among the plurality of templates, a template that matches a pattern of arrangement of the plurality of frames obtained by splitting the image by the splitter, and presents the template having the higher priority level to the user as a selection candidate.

5. The information processing apparatus according to claim 3, further comprising a splitter that splits the image into the plurality of frames along a line or a non-text portion in the image,
wherein the receiver sets a higher priority level to, among the plurality of templates, a template that matches a pattern of arrangement of the plurality of frames obtained by splitting the image by the splitter, and presents the template having the higher priority level to the user as a selection candidate.

6. The information processing apparatus according to claim 1, wherein the receiver receives the operation of specifying the order of the plurality of frames on the image displayed on a screen.

7. The information processing apparatus according to claim 1, wherein the receiver receives the operation of specifying the order of the plurality of frames by detecting a touch gesture made along the plurality of frames in the image on a screen based on the order of the plurality of frames.

8. The information processing apparatus according to claim 6,
wherein the receiver further receives, on the image displayed on the screen, an operation of specifying a frame where digitization is unnecessary among the plurality of frames, and
wherein the generator generates the output data without data in the specified frame.

9. The information processing apparatus according to claim 7,
wherein the receiver further receives, on the image displayed on the screen, an operation of specifying a frame where digitization is unnecessary among the plurality of frames, and
wherein the generator generates the output data without data in the specified frame.

10. The information processing apparatus according to claim 6,
wherein the receiver further receives, on the image displayed on the screen, an operation of specifying an image acquisition frame among the plurality of frames, the image acquisition frame being a frame in which texts and other objects are acquired as image data, and
wherein the output data includes, as the pieces of digitization data, the image data in the image acquisition frame, and text data obtained through character recognition for an image in a frame other than the image acquisition frame.

11. The information processing apparatus according to claim 7,
wherein the receiver further receives, on the image displayed on the screen, an operation of specifying an image acquisition frame among the plurality of frames, the image acquisition frame being a frame in which texts and other objects are acquired as image data, and
wherein the output data includes, as the pieces of digitization data, the image data in the image acquisition frame, and text data obtained through character recognition for an image in a frame other than the image acquisition frame.

12. The information processing apparatus according to claim 8,
wherein the receiver further receives, on the image displayed on the screen, an operation of specifying an image acquisition frame among the plurality of frames, the image acquisition frame being a frame in which texts and other objects are acquired as image data, and
wherein the output data includes, as the pieces of digitization data, the image data in the image acquisition frame, and text data obtained through character recognition for an image in a frame other than the image acquisition frame.

13. The information processing apparatus according to claim 9,
wherein the receiver further receives, on the image displayed on the screen, an operation of specifying an image acquisition frame among the plurality of frames, the image acquisition frame being a frame in which texts and other objects are acquired as image data, and
wherein the output data includes, as the pieces of digitization data, the image data in the image acquisition frame, and text data obtained through character recognition for an image in a frame other than the image acquisition frame.

14. The information processing apparatus according to claim 1,
wherein the receiver further receives an operation of specifying a data format of the output data on the image displayed on a screen, and
wherein the generator generates the output data in the specified data format.

15. The information processing apparatus according to claim 2,
wherein the receiver further receives an operation of specifying a data format of the output data on the image displayed on a screen, and
wherein the generator generates the output data in the specified data format.

16. The information processing apparatus according to claim 3,
wherein the receiver further receives an operation of specifying a data format of the output data on the image displayed on the screen, and
wherein the generator generates the output data in the specified data format.

17. The information processing apparatus according to claim 4,
wherein the receiver further receives an operation of specifying a data format of the output data on the image displayed on a screen, and
wherein the generator generates the output data in the specified data format.

18. The information processing apparatus according to claim 5,
wherein the receiver further receives an operation of specifying a data format of the output data on the image displayed on the screen, and
wherein the generator generates the output data in the specified data format.

19. The information processing apparatus according to claim 1,
wherein the receiver further receives an operation of specifying image order, which is order of a plurality of images,
wherein the receiver receives an operation of specifying order of a plurality of frames in each of the plurality of images, and
wherein the generator generates combined output data about the plurality of images by arranging pieces of output data about the plurality of images based on the image order.

20. A non-transitory computer readable medium storing a program causing a computer to execute a process comprising:
receiving, from a user, an operation of specifying order of a plurality of frames in an image; and
generating output data associated with the image so that pieces of digitization data in the plurality of frames are arranged based on the specified order.
